(19) United States
(12) Patent Application Publication
(10) Pub. No.: US 2004/0248637 A1
(43) Pub. Date: Dec. 9, 2004

(54) Interactive networked game

(76) Inventors: Dawid J. Liebenberg, Stellenbosch (ZA); Martin du Toit, Bellville (ZA)

Correspondence Address: CRAIG OPPERMAN, 450 JUANITA WAY, LOS ALTOS, CA, 94022, US

(21) Appl. No.: 10/457,060

(22) Filed: Jun. 6, 2003

(51) Int. Cl. A63F 13/00

(52) U.S. Cl. 463/16; 463/42

(57) ABSTRACT

This invention allows users to register interests in pre-determinable possible outcomes for a fixed-time event. The system comprises a plurality of remote networked user devices, which include respective displays and input devices such as keypads or keyboards for receiving user inputs in response to information displayed on the display. These devices are connected through a communications network via peer-to-peer and/or via one or more server-based connections. More specifically, the system allows an offering user to offer an interest in a first pre-determinable possible outcome for the fixed time event at a given interest multiplier. It also allows an acquiring user to request an interest in the first pre-determinable possible outcome at the given multiplier. The system then matches the offer and the request to define a commitment by the acquiring user to acquire the requested interest at the given multiplier.

### FIELD OF THE INVENTION

This invention relates to an interactive networked game and, more specifically, to one for presenting information to users interested in a specific fixed-time event and for allowing those users to register interests in that fixed-time event and to interact with each other based on those interests.

### BACKGROUND

The Internet has allowed many computer users to interact with each other and with computers in a networked environment. Not surprisingly, networked games have become increasingly popular with many users, especially young males.

In addition, websites such as Neopets (see www.neopets.com) have become very popular with young girls in particular. Once a subscriber has registered, he or she (typically she) can play various games to acquire “neopoints” that can then be traded for various items such as “neopets,” which themselves can be exchanged, etc. Of the many games, there is a large selection of “games of chance,” which include “neo” versions of the adult games of chance such as wheel of fortune (Wheel of Excitement on neopets); slot machines (Scorchy Slots), etc. Neopets also has a number of games that require a certain amount of skill, including a number of multi-player games that require a user to login to play. Thus neopets allow users to join a community in which most, if not all, the registered members have an interest in the subject of neopets.

Other networks allow people to register interests in subjects and events. Examples of these include message boards and chat rooms. Similarly, companies such as online auction provider eBay allow users to register an interest in an item. In eBay's case, the interest can be that of a seller listing an item for sale or a bidder registering and placing a bid on the item. EBay therefore provides an exchange of sorts in that it provides an electronic market place. But, the eBay system deals in items not fixed-time events and it does not deal in a range of pre-determinable outcomes in those events, putting aside a buy or sell outcome, of course.

Yet other businesses such as online betting company betfair.com allow users to register interests (bets) in a specific event such as a sporting event. Betfair.com's technology is described in published PCT application Ser. No. WO 01/77861. Another online betting technology is described in U.S. Patent Publication # 2002/0155885 entitled “Computer systems and methods for on-line user community where users can bet against each other.”

### SUMMARY

The system of this invention provides another method that allows users to register interests in pre-determinable possible outcomes for a fixed-time event. The system comprises a plurality of remote networked user devices, which include respective displays and input devices such as keypads or keyboards for receiving user inputs in response to information displayed on the display. These devices are connected through a communications network via peer-to-peer and/or via one or more server-based connections.

More specifically, the system allows an offering user to offer an interest in a first pre-determinable possible outcome for the fixed time event at a given interest multiplier. It also allows an acquiring user to request an interest in the first pre-determinable possible outcome at the given multiplier. The system then matches the offer and the request to define a commitment by the acquiring user to acquire the requested interest at the given multiplier. If a full match cannot be made, the system completes only a partial match to define partial commitment.

In addition, the system gives users an option to acquire a second interest in a pre-determinable possible outcome in the fixed time event, different from the first pre-determinable possible outcome, and at a fixed option commitment calculated based on a pre-defined “strike price” and the multiplier. Often the second predetermined outcome is the opposite of the first outcome.

If the user is the offering user, the option to acquire a second interest in the pre-determinable possible outcome is typically either an option to buy a call option or to sell a put option. But, if the user is the acquiring user, the option to acquire a second interest in the pre-determinable possible outcome is typically either an option to sell a call option or buy a put option.

Usually, the operator of the networked system defines the strike price and the option commitment as the strike price or difference between 100 and the strike number, factored by the multiplier.

Moreover, the system is configured to allow the respective user(s) to dispose of their acquired interest(s) in the second pre-determinable possible outcome before the end of the fixed time event.

In the system, the fixed-time event can be a sporting event in which users can confirm an interest with a single interaction on the input devices.

Typically, the system services many offering and acquiring users and matches multiple requests to acquire and offers of the first possible outcome, thereby defining commitments between multiple respective requestors and offerors. In other words, it acts as a kind of exchange.

It is possible for the remote devices to be personal computers, television receivers and/or wireless devices. Wireless devices could include mobile telephones, a personal digital assistants and/or portable computers.

For user convenience, the display includes a real time data display of information relating to the fixed time event and a mechanism is provided to update non-real time information on the display at a user-defined interval, for example every 100 seconds.

It is possible to use the system with user reward points, similar to the “neopoints” system described above. It is, of course, possible to use the system with real money.

### DESCRIPTION OF THE DRAWINGS

In the accompanying drawings:

FIG. 1 is a schematic illustration of the networked system of the invention;

FIG. 2 is a generic user interface for displaying information for use with the invention;

FIGS. 3(a) to (c) are examples of a user interface illustrating the steps by which a user registers and acquires interests in a fixed time events;

FIG. 4 is an example of a “bell curve” graph that can be used to assist the user in making choices about acquiring interests; and

FIGS. 5 to 9 are graphical illustrations of gains and risks associated with various types of interests in a fixed time event and which could be shown to a user of the system of the invention.

### SPECIFIC DESCRIPTION

I. Overview

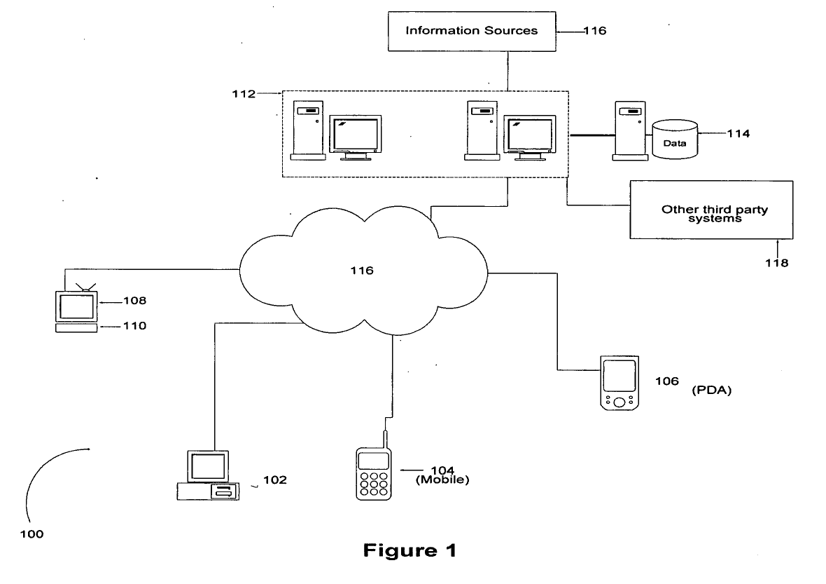

FIG. 1 schematically illustrates a secure networked system 100 according to the invention. As shown, the system 100 includes a plurality of client or end user devices such as personal computers 102. These could also be other devices such as mobile phones 104, personal digital assistants (PDAs) 106, television receivers 108, whether connected to a set-top box 110 or not, or another client device (not shown). These devices 102 to 110 are connected to one or more servers 112, which can be connected to yet other servers or information sources such as a back-office database server 114. Client devices 102 to 110 connect for two-way communication to the server(s) 112 over the appropriate network 116, which could, for example be the Internet, a mobile phone network, a LAN or cable or satellite network.

As illustrated, server(s) 112 typically represent more than one sever or, at a minimum, servers 112 can have numerous functions. So, for example, servers 112 can be a “server farm” of different servers each replicating similar or identical functionality. This replication or redundancy provides a more robust system that can more easily overcome catastrophic or other serious server failures.

In addition server(s) 112 can be connected to one or more database servers 114 on which fixed-time event information is stored. This information could, for example, include statistics, images, real-time information previously received and displayed to end users, user information such as login passwords, etc. Server(s) 112 can be directly or indirectly connected to one or more real-time (or other) information sources 116. These information sources would typically provide information about the real-time event, before, during and at the end of the event. Servers 112 are also shown connected to other third party systems 118. Examples of these could be “legacy” systems on top of which the system of the invention resides. If the system is used in a “for money” environment, it could be connected to back-end financial systems such as banking systems through usual access mechanisms.

Connections and interfaces between these various servers and/or the various client devices is by way of known calls and/or application program interfaces (APIs) and will not be described in detail here.

II. Initial User Interaction

Initial user interaction with the system 100 follows relatively standard and well-know protocols for secure networked systems. If previously registered, the end user merely logs-in. As only registered users can register interests on the system—subject to meeting certain criteria such as sufficient credit in their account—end users must go through a registration procedure. As with many secure networked systems, guest access is also provided, but unregistered guests are not allowed to register interests on real events. Instead, as with websites such as www.neopets.com, guests are given “read only” access to some information screens. In addition, guests can access real-time demonstrations of how the system works. This allows them to learn about the system without the perceived “barrier” of having to provide persona information to a computer network.

For convenience, registration or login can be commenced by single interaction with an appropriate button visible on the screen. As is typical, the registration procedure involves providing personal details, for example, an e-mail and/or physical mailing address, a user name and a password as well as financial related information if necessary.

Once registered, an “account” is opened for the user. User credits, such as “frequent-user” points or financial credits can be credited into the account via the appropriate network, a secure cash payment system, telegraphic transfer, telephone or other method.

III. A User-Centric Interface for Use with the System

As will be apparent to people skilled in the art, the system of the invention has many possible applications. For example, one such use is for educating people about hedging risks using the concept of options.

Another illustrative application of the system of the invention is for registering interests in an event such as a sporting event. These events are fixed-time in nature and have pre-definable possible outcomes. They usually have clearly identified participants (teams, players, horses, motor vehicle drivers, etc. whether in the real or the “virtual” world), some of which are better known and attract more interest than others. In a typical sporting event, the pre-definable possible outcome could be a win or loose for a particular team, person, horse, etc. or a particular specified winner.

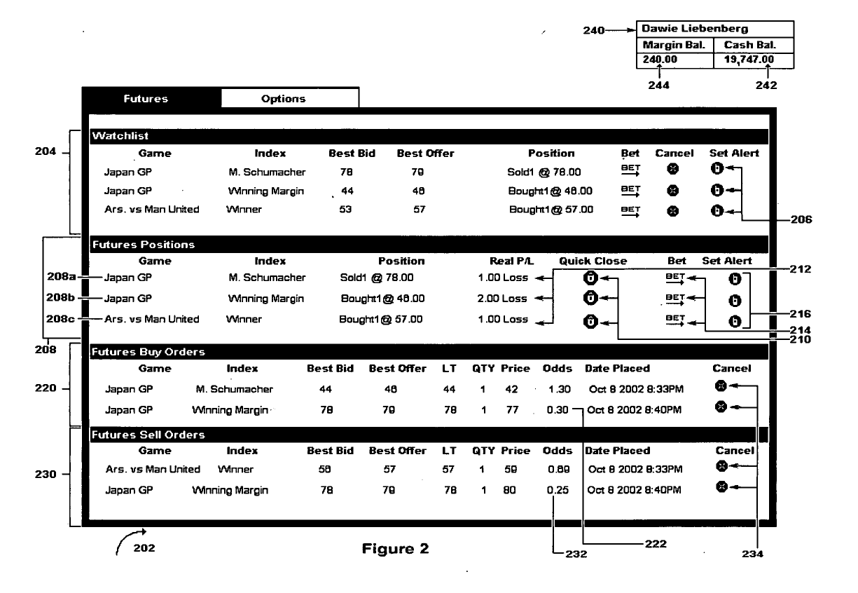

End users who wish to register an interest in any of these possible pre-determinable or pre-determinable outcomes in this kind of fixed-time event can use the system 100 to do so. More specifically, as shown in FIG. 2, the invention provides a user-centric interface 202 that displays detailed information about any number of different interests in a number of different pre-defined outcomes in any number of different fixed-time sporting events. As can be seen, screen 202 displays information about interests in various sporting events. Thus, panel 204 in the information screen 202 is a “watch list” for various “games” or sporting events such as the Japanese Grand Prix and the Arsenal vs. Manchester United soccer match in the United Kingdom.

Users can register an interest in these (or other) sporting events by placing the specific team or event on the “watch list” in panel 204. A “set alert” button 206 on panel 204 is also shown. Once an “alert” is set, the system could, for example, communicate with the user by sending an SMS message to a mobile telephone, cause an audible tone to be produced at a user device, initiate a “pop up” screen on a personal computer display, or by any other appropriate method. Alerts could, for example, be set to notify users of specific events such as a catastrophic accident in the practice rounds of the Japanese Grand Prix or, for that matter, the effect of a change in the interest in the vent by others.

Another example of registering an interest is placing a bet on the outcome of a sporting event. This type of interest is reflected in panel 208 on screen display 202. In this panel-208 example, the user has registered betting interests at 208a in the pre-determinable outcome of racing driver Schumacher winning the Japanese Grand Prix at an “interest multiplier” of 78.00. The significance of this multiplier will be explained below. The same user has also registered an interest at 208b in the predetermined outcome of driver Schumacher winning by a certain margin. The multiplier for that interest is 46.00. That same user has also placed a bet at 208c on Arsenal beating Manchester United.

This screen panel 208 also provides the user with the opportunity to “close” a specific position, say the position reflected at 208a, using a “quick close” button 210. This “quick close” button allows the user to liquidate or “close” a selected position 208a, 208b or 208c with a single interaction, such as a single computer mouse click or single interaction with a specific key on a television remote control or the “*” key on a mobile phone, for example. In that case, the specific gain or loss (P/L) for that transaction will be that shown at 212.

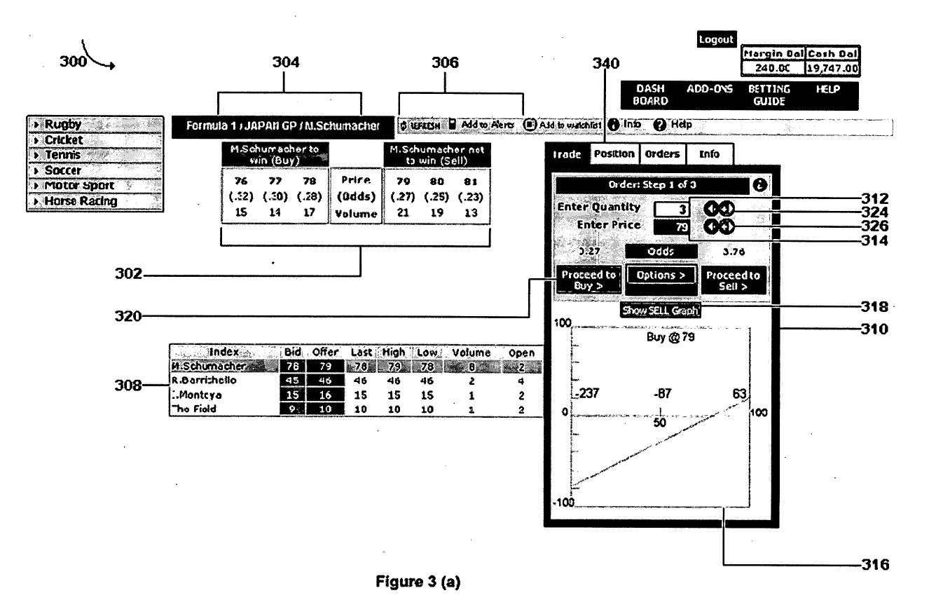

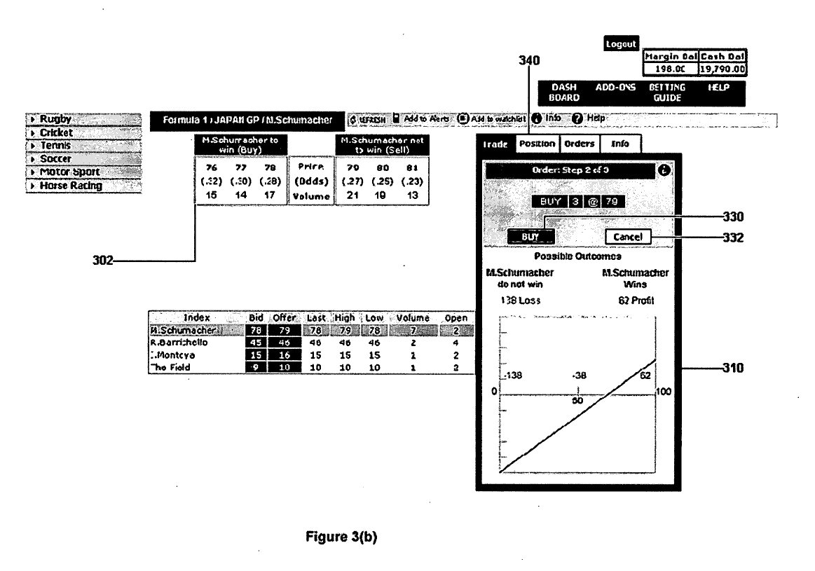

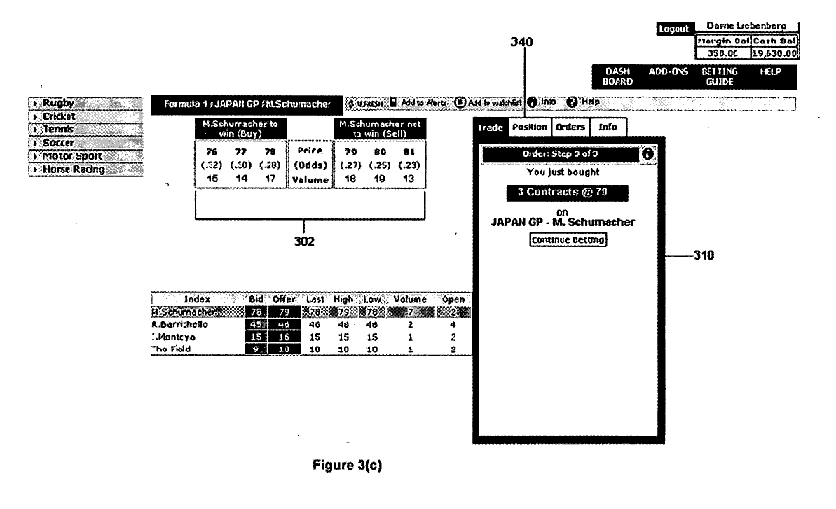

Panel also allows the user to move to a separate screen at which interests can be registered. In this example, this equates to bets being placed. The links 214 from which to do so are typically activated by one or two interactions or “clicks” with the appropriate input device upon which the user is directed to an interest registration screen (betting screen) similar to the one described below with reference to FIGS. 3(a) to (c).

As can be seen, panel 208 also has Set Alert buttons 216 similar to set alert buttons 206 in panel 204. In the betting example above, these set alert buttons 206 or 216 can be used to activate an alert for specified betting related positions. For example, an alert can be set to notify a user when a certain multiplier (odds) is being offered for a specific event.

Screen 202 also includes display panels 220 and 230, respectively reflecting Future Acquire (Buy) Orders and Future Offers. These screens reflect orders placed by the user in advance of certain multiplier (odds) occurring. So, for example, panel 220 in column 222 shows that this user has placed a buy order (i.e., registered a willingness to acquire an interest) for a unit at a multiplier (odds) of 1.30 that driver Schumacher will win the Japanese Grand Prix. Similarly, column 232 in panel 230 reflects that this user has placed two future sell orders (i.e. registered a willingness to offer an interest) at a odds of 0.69 and 0.25 respectively. The date at which these (buy or sell orders) were placed is reflected in the respective panels 220, 230.

Until such time that any such order is not filled, i.e., when the system has matched a seller or buyer with this user's buy or sell order, this user can cancel the order with a single click of a “cancel” button 234. If, however, any seller or buyer for the same interest at the same is located by the system, the order is automatically filled and that order gets reflected in “Futures Positions” panel 220. Thus, by matching offering users with acquiring users, the system of the invention acts as an exchange for interest in pre-determinable outcomes in fixed time events. In this example, therefore, it serves as a betting exchange.

At the top right corner, screen 202 also reflects the user's name in box 240. It also shows that user's total number of credits for use in box 242. User's cannot commit to spending more credits than are reflected in box 242.

It goes without saying that end users cannot register interests (place bets in the betting example) unless they have sufficient credits or funds in their account to cover the worst possible outcome of the registered interest. In the betting example, the maximum amount an end user can lose is equal to the bet (often called the stake) when backing (acquiring/buying) an event. When laying (“selling”) an event, the amount that could be lost is equal to the stake multiplied by the odds. If an end user backs more than one outcome in a particular event the maximum loss is simply the sum of all the stake money wagered.

Finally, the system keeps continuous track of every end user's exposure. Since the system of the invention does not know in advance whether the Positions in 208 will be positive or negative or whether the Future Offers reflected in panels 220 and 230 will be filled, the system 100 assumes the worst possible outcome of each registered interest, whether actual or possible, bearing in mind any interdependencies that may exist between them. This maximum exposure is also shown on screen 202 and is reflected as the user's “Margin Balance” in box 244. I.e., The margin balance is the highest amount of possible loss the user can incur if all positions (registered interests combined with their respective multipliers) taken by that user go against that user. In the betting example, this would be the same as if that user lost all the bets, both actually placed and possible.

Thus, the system 100 gives the user a single, unified, user-centric view of all the interests in all the fixed time events for which the user has registered any interest. This is in contrast to a view of interest based on the events themselves. Thus, users can quickly view all interests that are outstanding, both those that have been filled and those that are pending. This list can be sorted by event, by size of bet and by type of bet. An end user can also obtain a complete historical list of all bets placed and the outcome of each bet (i.e. win or lose). Furthermore, the end user can analyze betting history in a number of ways, for example over any time period and for individual sports. All historical bets can be sorted by sport, by size, by type and by success/failure.

IV. Using the System to Offer or Acquire an Interest in a Pre-Determinable Possible Outcome

As indicated above, the system 100 allows users to offer an interest in any pre-determinable outcome in a fixed-time event as well as allowing potential acquiring users to request that interest. The system 100 thus creates an exchange mechanism between the offering and acquiring users.

Continuing with the betting example above, it will be apparent that the system 100 allows sellers and buyers of interests in pre-determinable outcomes to come together on the system. Buying an outcome in the betting example means that the end user bets that the outcome will occur and if it does, make a profit when that happens. If the outcome does not occur, then the end user loses the original amount placed on the bet. In betting, this is sometimes referred to as the stake. Conversely, when selling (offering up) an interest in the outcome, the end user receives the stake money and, if the outcome does not occur, keeps this stake money, thus making a profit. But, if the outcome does occur then the end user loses the stake money multiplied by the multiplier (the odds) at which the stake was accepted.

This is illustrated using the example of a fixed time event such as the Japanese Grand Prix Formula 1 motor race with users registering an interest in (betting on) race driver Schumacher to win. In the simplest example, there are two possible pre-determinable outcomes: either (a) Schumacher wins or (b) Schumacher does not. By way of example, assume an interest multiplier (odds) on these two possible pre-determinable outcomes as follows: “Schumacher to win” has odds of 1.27 while “Schumacher not to win” has odds of 2.73.

Now, assume further that user Dawie bets on the race by acquiring an interest (buying) in Schumacher winning for 1,000 points (i.e. he bets that Schumacher will win) and user Martin offers up an interest (sells) in Schumacher winning for 1,000 points, (i.e. he bets that Schumacher will not win). The system will match these to users and, if Schumacher wins, Dawie will receive 1,270 points in return for his 1,000-point interest. This is Dawie's original interest of 1,000 multiplied by 1.27. If Schumacher wins, Martin has to pay Dawie the 1,270 points.

Of course, this is a very simplified example with only two people. FIGS. 3(a) to (c) therefore illustrates how this system works when a large number of people are involved in exchanging interests at given multipliers.

In FIG. 3(a) a user interface screen 300 reflects the information as it might appear after a number of bets (i.e. more than just Dawie and Martin's bets) have been placed for the Japanese Formula 1 Grand Prix race. In “pricing screen” 302 of screen 300 the interests for both sides of the market for all possible outcomes for the fixed-time event (Japanese Grand Prix) are given. Note, this screen is an event-centric screen, not the user-centric screen and is accessed by interacting with the “bet” button on user-centric screen 200 illustrated in and described with reference to FIG. 2.

As is shown in screen 300, one side 304 of the box 302 reflects the acquiring or “buying” side, in which the prices and sizes available to buy an outcome are displayed. Thus, for result “Schumacher to win” there are 17 requested units at a multiplier of 78.00. This multiplier is also reflected as odds of 0.28. Similarly, there are 14 requests at a multiplier of 77.00 (equating to odds of 0.30) and so on. The other side 306 is an offering or selling side reflecting users offering 21 units at a multiplier of 79.00 (equating to odds of 0.27) that Schumacher will not win. Similarly, there are 19 offers at a multiplier of 80 (equating to odds of 0.25), etc. All this information is an aggregation of the all user inputs that are summarized for each individual user on user-centric screen 202, more specifically on the Future “Buy” and Sell panels 220 and 230 respectively shown in FIG. 2.

Before proceeding further, it is important to explain how the multiplier(s) operate(s) in this example. A multiplier, say 78.00 on buy side 304 is on a scale on 1 to 100. This means that a user must bet or commit 78 points to get back 100 points if a positive outcome occurs. I.e., it will cost 78 to get an additional 22 points for a total of 100, if the bet is won. The odds (0.28) shown are based on this. Thus 0.28 is equal to 22 divided by 78, i.e., the ratio of win (without the stake) to stake.

In addition, it is important to note here that the odds multipliers reflected here in this example must be amended to reflect the digital odds convention often used by bettors. Thus, the multiplier 0.28 reflected in box 302 equates to a digital odds multiplier of 1.28. I.e., the convention for digital betting is that odds are displayed inclusive of the stake. Thus, odds of 5/4 are shown as 2.25, which is 1.25 (i.e., 5/4) plus 1. Thus, in this invention, the word “multiplier” must be construed to include any of the above described multiplier factors—odds, digital odds and a multiplier based on a 1 to 100 scale—as well as any other form of multiplier such as ratios or percentages.

Returning to the example, box or pricing screen 302 shows, the best two prices currently available one on each side 304 and 306 of the market and the number of possible bets that can be taken at those multipliers. So, for example, an end user can buy Schumacher to win at a multiplier of 79.00 or digital odds of 1.27, which is the reflected odds multiplier of 0.27 plus 1. [As a point of reference, these odds can be reflected as 0.27 to 1, i.e. approximately 1/3] These bets are shown on the “available” side 306 of screen 302. The total possible number of contracts that can be immediately bought at this multiplier is 21. As is evident, these 21 possible bets, or contracts as they are sometimes known could be offered by, one or more offering users. Thus, an acquiring user can acquire up to 21 contracts. For each acquired contract, that user will receive back $127 for every $100 staked if Schumacher wins. Of course, if Schumacher does not win, that user will loose each point or $ used to acquire the interest.

Similarly, side 304 of box 302 shows that one or more acquirers have pre-registered a total of 17 possible contacts at a multiplier of 78. This means that any user can now offer up to 17 contacts at a multiplier of 78 and the system will immediately match one or more buyers. Thus, the system operates as an exchange by matching requests and offers and thereby defining a commitment between requestor and offeror or offerors as the case may be.

Other entries on the display screen 308 show that, for example, interests can be registered on pre-determinable outcomes of Barrichello, Montcya and “The Field,” winning. An interest in “The Field” is one indicating that any racing driver other than Schumacher, Barrichello or Montcya will win the Japanese Grand Prix.

FIG. 3(a) also shows a graphical visualization “box” 310 of the effect of a possible registration of an interest. In this case, the user has entered into block 312 an interest to acquire 3 units at the multiplier 79 shown in block 314. As is evident from “sell” side 306 of block/pricing screen 302, this is the best possible multiplier at which a seller is prepared to offer up an interest in Schumacher winning. [I.e. the offering user believes that Schumacher will not win]. Before the acquiring user confirms the interest in the system—and the system “fills” the transaction—the system graphically shows the user the effect of acquiring the interest. On the left side of the graph 316 the user is shown the exposure for the proposed transaction. In this case it is −237, i.e. 3 units times 79 if Schumacher does not win, while on the right side of the graph, the user is shown the potential upside from the interest if the pre-determinable outcome (Schumacher winning) occurs. In this case it is 63.

FIG. 3(a) also shows that an interest can be registered in three different ways on this screen 300. It can be registered by selecting the appropriate side of the pricing screen (also known as a depth table) 302, whether the left side for buying or the right side for disposing of an interest. Alternative, a user can fill in quantities (volume and price) in boxes 312 and 314. In addition, the user can use the little arrows 324 and 326 to “scroll” the volume and price.

As will be apparent to one skilled in the art, the system could alternatively allow offering users to show the opposite effect, i.e., the effect of giving up the interest, by selecting the “show sell graph” button 318 in graphic box 310.

Once the end user decides to buy, the “proceed to buy” button 320 is selected and the confirmation screen, as shown in FIG. 3(b), is presented to the user. In this screen a total number of 3 units are about to be acquired, so the graph 316 in box 310 show the total possible exposure −138 and upside +62 available to the user. This is the total for all bets placed by the user and not just for the buy described with respect to FIG. 3(a) above. At this time the end user is given the option to acquire by selecting “buy” button 330 or cancel the interest, by selecting the “cancel” button 332.

Once the end user has selected the buy button 330, box 310 confirms the acquisition and gives the user the option to continue registering interests in this or another event. This is illustrated in FIG. 3(c). In addition, as soon as the transaction has been entered and confirmed by the system 100, all end users looking at the pricing screen 302 for the Japanese Grand Prix will see their screens update immediately to show the new price and size quotations. As can be seen from this FIG. 3(c), the “volume” line in screen 302 now shows only 18 contracts available for sale at 79, while in FIGS. 3(a) and (b), this was 21.

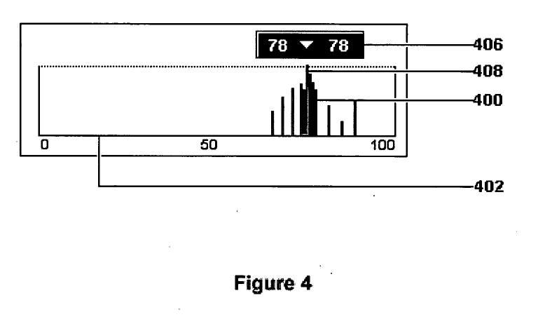

The system could also include a graph (such as a standard “Bell” distribution 400 in box 402 in FIG. 4) reflecting the density of buyers and sellers at different prices for a specific event outcome. For example, the horizontal scale of the chart could reflect various “prices” of the interest while the vertical scale could represent a represents the number of possible of contracts available at each price point. The system could also add a “slider” visualization 406, which can be “dragged” across the top of the box 402 to make it easier for a user to specify an interest—say, volume or price—in a possible outcome. The actual price, in the FIG. 4 example, a price of 78 is shown by full height vertical line 408 extending top to bottom in the box 402.

V. Updating or “Refreshing” Information Presented to the End User

This updating of the view offered to the user is particularly important as users often wish to make quick “real-time” decisions about registering an interest. The system 100, therefore, allows users to manually or automatically refresh their screen displays. Manual refresh can be done by, for example, selecting a refresh button that is present on conventional Internet browsers or by selecting a refresh button provided on many, if not all, screen displays by the system 100. In addition, the user can select an automatic refresh function in which the refresh frequency of, say, every 100 seconds is specified by the user. Using this feature is beneficial, as the user does not have to remember to refresh the view.

The system 100 is also able to provide, directly or indirectly, the end user with a real-time or near real-time data feed of information relating to the fixed time event. This information can be displayed at any convenient location on the display and can use appropriate technologies or data sources for the information. For example, if the user is accessing the system 100 via a television, the real time data feed could be implemented in a Teletext-like manner with the real-time data feed scrolling along the bottom of the television screen.

VI. Canceling and Partially Meeting Registered Interests

As referred to in FIG. 2, the user is given the opportunity to cancel a future order, whether an order to acquire (buy) or dispose of (sell.) This is by using the cancel buttons 234. Inherent in this functionality is that only un-matched or partially orders can be cancelled. Thus, in response to selecting the “cancel button” 234, the system checks to see whether the order has already been wholly or partially filled/ matched up with a corresponding, but opposite, interest. If the order has already been wholly or partially filled, the system 100 cancels as much of the order amount as possible and confirms this to the end user. If the order amount has not been filled, cancellation is confirmed.

VII. Arbitrage

There will be occasions with fixed odds betting when, even though one side of the market has not been taken up, it will still be possible to fill bets on the other side of the market, an operation which is referred to as “arbitrage.” The system 100 performs an arbitrage function by automatically filling bets in such a way that the system operator does not lose. Arbitrage opportunities arise where a collection of bets of a similar type (i.e. to back or to lay), all on the same event, can be filled automatically by the system in the sure knowledge that whatever the outcome of the event, the system operator will not lose.

For example, Dawie is prepared to put $120 on team A to win at a price of 2. 0 and Martin is prepared to back team B to win at a price of 3.0, also for $120, and both have entered their requests into the system, as described above. The system 100 will now automatically create an implied bet, namely a price at which it is willing to lay the draw. In this example the system lays the draw for $40 at a price of 6.0. If there is now someone prepared to lay the draw, the pricing screen shows that end users can back the draw immediately, for a total of $40 at a price of 6. 0. Assuming Ruben now decides to accept the odds being offered for the draw and backs the draw at 6.0 for the whole $40, his bet will immediately be taken up. At the same time, all of Dawie's $120 bet will taken up, in which all of the bets have been executed, leaving $40 of Martin's bet unfilled.

Therefore, in this instance, even though no individual explicitly stated that they wanted to lay any of the outcomes, the betting exchange system is able to transact three separate bets.

VIII. Options Betting

The system of the invention can also be used to exchange “options” to dispose of or acquire an interest in the possible outcomes. I.e., the user commits a fixed option commitment lower than the current trading commitment and, in exchange, receives an option to acquire an interest in the event.

Before illustrating how the system can act as an options exchange as well, it is necessary to give an overview of what traditional options mean. This information is a paraphrase of that given at the Chicago Board Options Exchange website at http://www.cboe.com/LearnCenter/.

Basically, an option is a contract giving the option buyer the right, but not the obligation, to buy or sell an underlying asset at a specific price on or before a certain date. There are only two kinds of options: “Call” Options and “Put” Options. A Call Option is an option to buy at a specific price on or before a certain date. Put Options are options to sell the asset at a specific price on or before a certain date.

Call options can be thought of as security deposits. If, for example, you wanted to rent a certain property, and left a security deposit for it, the money would be used to insure that you could, in fact, rent that property at the price agreed upon when you returned. If you never returned, you would give up your security deposit, but you would (usually) have no other liability. When you buy a Call option, the price you pay for it, called the premium, secures your right to buy that certain asset at a specified price, called the strike price. If you decide not to use the option to buy the asset, and you are not obligated to, your only loss is the premium.

In contrast, Put options (options to sell) are like insurance policies. If you buy a new car, and then buy auto insurance on the car, you pay a premium and, hence, are protected if the asset is damaged in an accident. If this happens, you can use your policy to regain the insured value of the car. If all goes well and the insurance is not needed, the insurance company keeps your premium in return for taking on the risk. With a Put Option, you can “insure” the asset by fixing a selling price. If something happens to cause a fall in the asset price, thus, “damaging” your asset, you can exercise your option and sell it at its “insured” price level. If the price of your asset goes up, there is no “damage,” and you do not need to use the insurance. Once again, your only loss is the premium.

The strike (or exercise) price is the price at which the underlying asset can be bought or sold as specified in the option contract. For example, in the case of an asset XYZ, a XYZ “30” Call, the strike price of 30 means the asset can be bought for $30. Were this the XYZ “30” Put, it would allow the holder the right to sell the asset at $30. For each buyer of call or put options there must obviously be a seller of that call or put option. But, the rights and obligations of buyers and sellers are different. These are summarized in the table below:

TABLE
Respective rights and obligations of buyers and sellers of types of options.

| | Call Options | Put Option |
|---|---|---|
| Buyer | The right (but not the | The right (but not the obligation) |
| | obligation) to buy | to sell |
| Seller | The potential obligation to sell | The potential obligation to buy |

As shown in this table, people who buy options have a right, and that is the right to exercise. When an option holder chooses to exercise an option, a process begins to find someone (known as a writer) who is short the same kind of option. Once found, that writer may be assigned. This means that when buyers exercise, sellers may be chosen to make good on their obligations. Thus, when a call option is assigned, one or more call writers are required to sell their asset at the strike price to the call holder. When a put option is assigned, the opposite occurs. Put writers are required to buy the asset at the strike price from the put holder

By way of example: assume you are interested in XYZ asset, which is presently at $29. You think that this asset will go up in price to well past $30. You choose to buy an XYZ “30” Call options for $2, instead of buying the asset outright. This option gives you the right to buy the XYZ asset at $30 any time before the expiration date. For this right, you pay $2. On expiration, assume XYZ is at $35. You have a call option, which can be exercised to purchase the XYZ asset at $30. If you do that, you can then sell that asset and make a $5 return. Since your initial call premium (cost) was $2, your net profit is $3. You could also simply sell the option back at any time before expiration, and take the profit any profit on the option itself.

But, if you had been wrong about XYZ and it had gone down to $25, your only loss would be the premium amount you paid for the call option (i.e., $2), since the option would be worthless.

Let's do another example. Assume you have bought an XYZ asset at a price of $31. It is now at $32, but you are concerned that an adverse market may cause you to lose money on your XYZ asset, but you are not afraid enough to sell the asset. You could buy an XYZ “30” put option for 1, which would give you the right to sell your asset at a price of $30 in the event XYZ goes down in value. For this right, you pay $1.

Here's what happens. Since you bought the XYZ “30” Put, you have the right to sell your asset to someone at $30, no matter how low it goes. In this sense, it is like an insurance policy on your asset, fixing your maximum risk at $2. ($1 cost of the Put option and the $1 you could lose on the asset if it falls from your purchase price of $31 to your exercise price of $30). The position you get is identical to being long a Call. It has a limited risk, with unlimited upside.

The theory as explained by the Chicago Board Options Exchange is used by the system 100 as illustrated by application to the betting example used before. When used in the betting environment, these “options” are very beneficial as they can be very effective risk mitigation tools. To illustrate, the Japanese Grand Prix race will be used as an example.

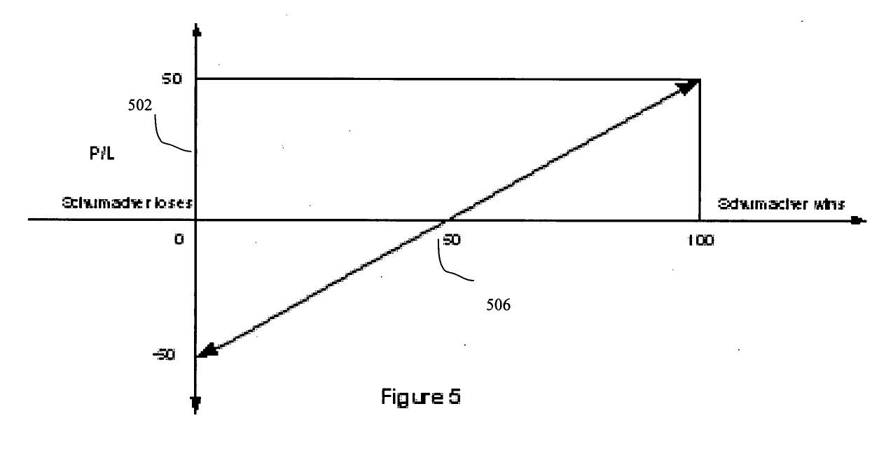

Assume that the market before the qualifying races have started is “trading” at a price of 49 points for sellers and 50 points for buyers on Michael Schumacher to win the Japanese Grand Prix. If a user believes that Schumacher will win this race, that user has the opportunity of buying at 50 points using the system 100 as described above. The maximum profit that user can make if Schumacher wins is 50 points. Similarly, if Schumacher loses, a maximum loss of 50 points will apply. This is illustrated in FIG. 5, which is a graphic similar to graph 316 in FIG. 3(a), but this time reflecting a 50 point downside 502 if Schumacher loses and a 50 point upside 504 if Schumacher wins. The point 506 on the horizontal axis shows the price (reflects the odds on a 100 point scale) of the interest.

As an alternative to, or more preferably together with placing this bet, the user can use the options feature of the system 100 of the invention. [As can be seen many of the user interfaces shown in the Figures include an “Options” tab useful for accessing the options functionality of this invention.]

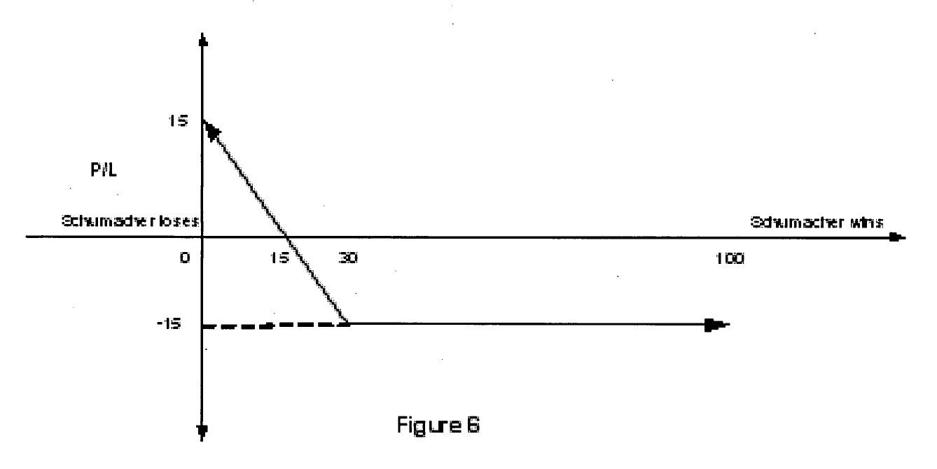

The system will also allow the user to buy a 30-point “put” option for, say, 15 points. The 30-point value is automatically generated by the system on a 30/70 scale, but this scale could be changed should the system operator so wish. This put option gives the user the option to sell the interest for 30 points at the end of the race and the cost of this option (interest) is 15 points. Now, if Schumacher looses the race the user will sell put option for 30 thereby making a profit of 15, which is the 30 points income less the 15 points it cost to acquire the put option. If Schumacher wins the race, the put option will be worthless and the user's loss will be the 15 points (shown at 602) option cost/premium. The risk profile for this put option is shown in FIG. 6.

It is important to note that the return on “investment” is identical in both FIGS. 5 and 6. In FIG. 5, the return is 50 points gain for 50 spent, which is 100%. In FIG. 6, it is 15 points gain for the 15-point option price, which is also 100%. Thus the “price” of an option is exactly the same (measured by ROI) than that of a bet placed prior to the event.

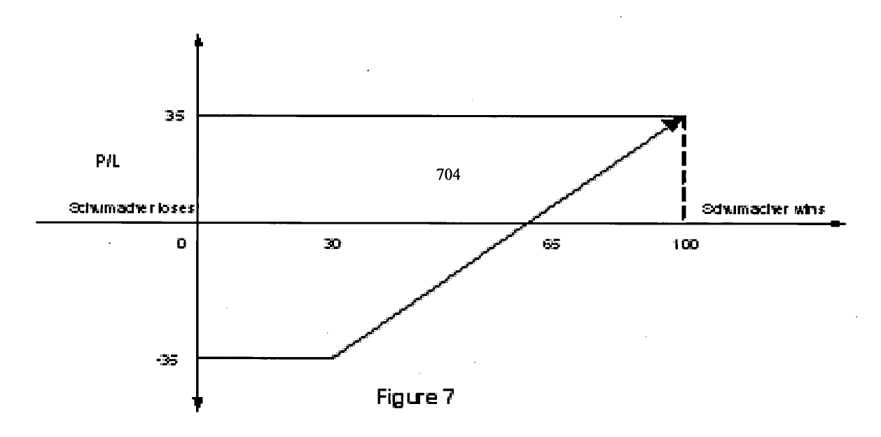

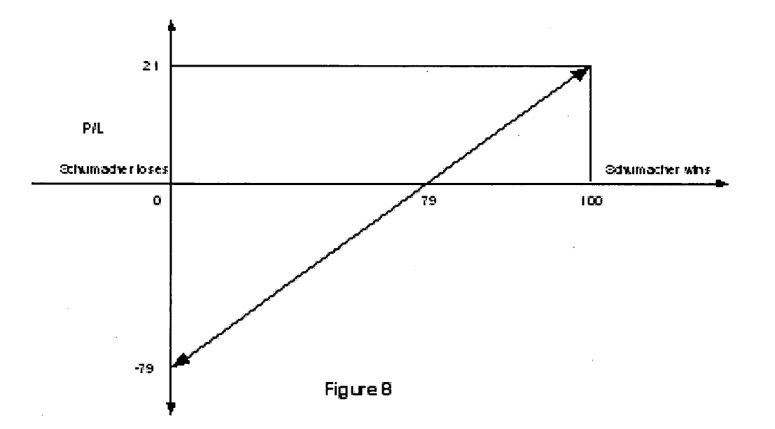

As mentioned above, the system 100 allows the user to acquire both interests. Thus, the user can both place a bet (acquire a future interest) and acquire a put option. The resulting risk profile, which is the mathematical sum of the Schumacher looses-side figures as well as the sum of Schumacher-wins figures, is shown in FIG. 7. As can be seen, the users' maximum exposure 702 if Schumacher looses is 35 points. If Schumacher wins, the maximum profit is 35 as shown at 704. As before, the return in this before-the-event scenario is 100%, being a 35-point upside for a maximum 35-point risk.

Thus, in this limited example, the system of the invention does not provide particularly different results for players who register all their interests before the event commences. But, as explained below, the system can be used to great advantage while a fixed-time event is occurring.

Before doing so, however, it is important to explain how the prices for both call and put options are determined by the system. Prices of options relating to securities (shares in companies) are calculated using a very complex formula known as the Black-Sholes formula. But, in the system of the invention, this is not necessary. The system is primarily concerned with fixed time events with pre-defined specific outcome. Thus, calculating the option price can be done using the following very simple formulae:

The price of a call option is given by: (1/buy odds)*(100−MP); and

That of a put option is given by: (1/sell odds)*MP

Where:

MP is the “measurement point” or strike price which is fixed by the system operator

“Buy odds” are the odds in, digital odds format, that it costs to buy a bet; and

“Sell odds” are the odds, in digital odds format, that it costs to sell a bet.

“Buy odds” are, for example, be shown on the left side 304 of box 302 in FIG. 3(a), while “sell odds” are shown on the right side 306 of box 302. The measurement point or strike price (MP) is typically 30 or 70.

As referenced above, the system of the invention allows users to acquire interest in pre-determinable outcomes in a fixed time event at any time up until the end of that event. Continuing with the Japanese Grand Prix race example above, assume the race is in its 21^{st} lap. At that time interests (bets) can be bought at 79 (i.e., there are sellers willing to sell at 79) or sold at 78 (i.e., there are buyers at 78) on Michael Schumacher to win the race. This, by the way, just happens to be the position illustrated in FIG. 3.

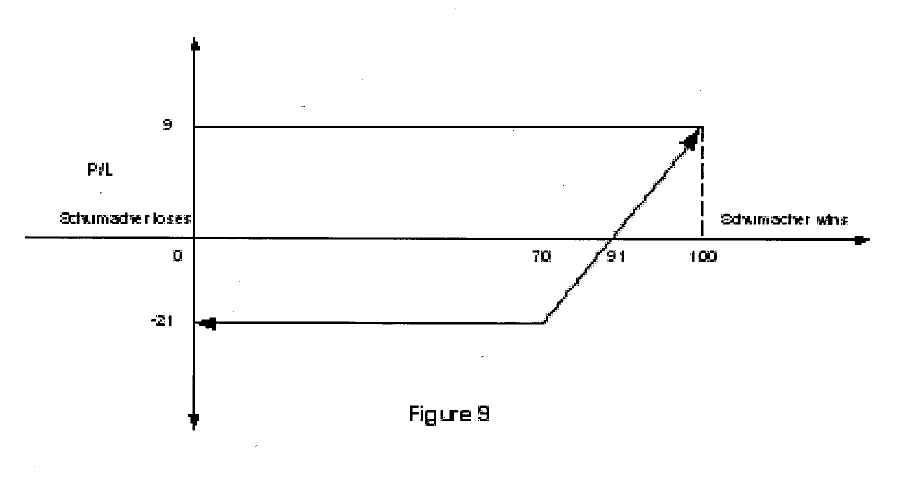

So, if the user believes that Schumacher will win the race the user could buy an interest at 79 on Schumacher winning the race. In that case, as shown in FIG. 8, the profit (shown at 802) is 21 if Schumacher wins. If he loses, the loss (shown at 804) will be 79.

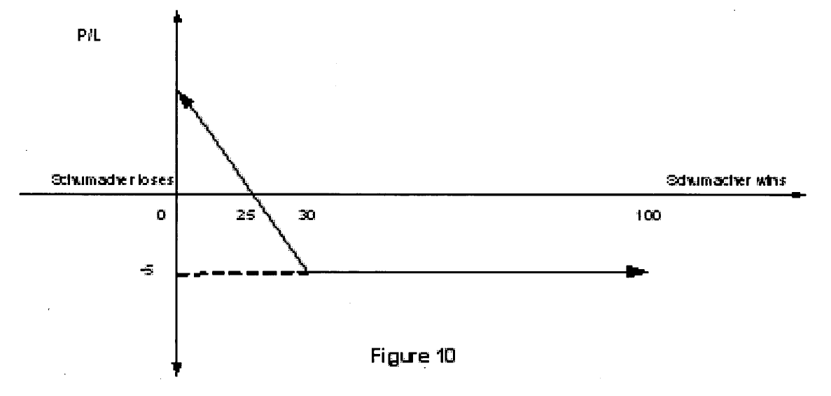

Another possibility is to use the options facility of the system and to buy a call option, i.e., the user acquires the right, but not the obligation, to buy an interest. Let's assume that the user buys a 70 Call option for 21. Thus, the user is spending 21 to have the right to pay 70 for an interest that will be valued at 100 if Schumacher wins. Thus, if Schumacher wins, this call option will yield a gain of 9, i.e., the 100 value, less the 70 the user has to pay less the 21 the user had to pay for the option. If Schumacher looses, the option is worthless and the user loses. This gain and loss are shown in FIG. 9 respectively at 902 and 904.

Unlike the before-the-race scenario described earlier, the return on investment for the FIG. 8 and FIG. 9 during-the-race scenarios are quite different. In the FIG. 8-example, it is 21/79, which is about 26%, while in the FIG. 9 call example; it is 9/21, which is about 43%.

It is, of course, possible register two or more separate interests in an event, in which the two (or more) interests complement each other. So, for example, someone who has placed a bet may also wish to acquire an option interest. This could, as explained above, be used to act as a way to mitigate losses/reduce risks.

IX. Hedging

Thus the system of the invention can be used as a “hedge.” A hedge is when options are bought or sold to reduce potential losses that can arise out of owning an underlying asset or potentially owning it.

Another illustration is from a fictitious example of Arsenal playing Manchester United at soccer in match in which the winner will host the FA Cup final. Hosting the FA Cup final event has a potential income upside—through advertising revenues, ticket sales, merchandising, etc—of, say, $10 million to the host. Assume, that betting is at 57 in favor of Arsenal winning. Now, Arsenal have the potential of owning an “asset” of a $10 million income should they host the FA Cup final. Using the system 100 of the invention, they can partially hedge them against losing this asset.

Arsenal can do this by buying a number of 30 Put options on ‘Arsenal to win.’ The price of that put option would be 5, say. This put option means that should Manchester United win, the holder will earn a profit of 25 points, being the difference between the 30 points and the 5 points premium. Thus, to hedge the full $10 million, Arsenal must buy 10,000,000/25=400,000 contracts. Each contract will cost the $5 options premium, so the hedge will cost $2,000,000.

Now, if Manchester United wins, Arsenal's Put options will yield $30 per contract. I.e., 400,000 contacts times $30 per contract will yield $12,000,000. Subtracting the hedge price of $2,000,000, results in a net profit of $10,000,000.

On the other hand, if Arsenal wins, the put options will be worthless and the $2,000,000 option cost will be lost. But, Arsenal will make a profit of $10,000,000 from hosting the final. Arsenal's net gain in this case will be $8,000,000.

Similarly, United can partially hedge themselves against losing this asset. This can be achieved by buying 70 Call options on the ‘Arsenal to win’ event. A call option at a price of 6 means that should Arsenal win, the holder will earn a profit of 24 points. Thus, to hedge United must buy 10,000,000/24=416,666 contracts. This hedge will cost $2,500,000, being $6 times 416,666 contracts.

If Arsenal wins Manchester United's call option will be worth $30. United will make 416,666* $30, i.e., $12,500,000. From this, they must subtract the initial options price of $2,500,000 to yield a net profit of $10,000,000. If United wins the match, however, their options will be worthless and the $2,500,000 will be lost. But they will profit from hosting the final to the amount of $10,000,000, yielding a final profit of $7,500,000.

As mentioned above, Arsenal was a modest favorite to win this match. The direct consequence of this of this is that the option price on United winning is less. Nonetheless, using the hedging mechanism described above, it is clear that both teams can profit irrespective of the outcome of the match. Importantly, the system 100 of this invention enables this. As can be seen, there are hundreds of thousands of options that must be bought by either or both team. Obviously, there must be sellers for each contract bought. This is obviously a huge numbers of sellers, something that is only possible with the large exchange mechanism that is enabled by the networked system of this invention.

X. Other User Interface Features

The system 100 has numerous other user interface features. For example, the user interface shown in FIGS. 3(a) to (c) also has a ‘Position’ tab 340 on the “trade box” 310 This reflects all positions—both options as well as futures positions and whether long (bought) or short (sold).

All end users receive a confirmation of the bets they have placed, for example over the Internet or by e-mail, SMS (Short Message System) or other appropriate mechanism. Users are able to specify how frequently these confirmations are sent, for example, after every bet, at the close of an event, at the end of each day and so on. In addition, end users are notified of all pending bets that have lapsed.

In addition, the system of the invention can also produce a comprehensive statement of account if the user requires. This account can be produced in screen, can be faxed automatically or can be mailed to the user, whether by e-mail or in the regular mail system. Such statement will typically show details of all transactions that impact the user's account (e.g. deposits, withdrawals, etc) and will provide a full reconciliation showing how current balances have been achieved.

The system allows users to tailor the display and or system to meet their own requirements. For example, they can decide what level of confirmation they require when placing bets, choose how the betting information appears on the screen, for example, view more than one market on a screen at any one time or create individually customized own composite pages, and select how graphically intensive the various screens are. Another example of tailoring would be changing the “quick close” button 210 from a single action to a multiple action, say one in which “confirmation” is required.

In the foregoing specification, the invention has been described with reference to specific embodiments. It is, however, evident that various modifications and changes may be made to it without departing from the broader spirit and scope of the invention. The specification and drawings are, accordingly, to be regarded in an illustrative rather than a restrictive sense. In addition, all publications referred to in this application are hereby incorporated by reference.

What is claimed is:

1. A networked system for allowing users to register interests in at least one of a plurality of pre-determinable possible outcomes for a fixed-time event comprising:
a. a plurality of remote user devices, at least one of which includes
i. a display and
ii. an input configured to receive user inputs in response to information displayed on the display; and
b. a communications network to which the plurality of user devices are connected,
wherein the system is configured to
i. allow an offering user to offer an interest in a first pre-determinable possible outcome for the fixed time event at a given interest multiplier,
ii. allow an acquiring user to request an interest in the first pre-determinable possible outcome at the given multiplier,
iii. match at least a portion of the offer and the request to define a commitment by the acquiring user to acquire the requested interest at the given multiplier, and
iv. giving users an option to exchange, at later time and at a fixed option commitment based on a pre-defined “strike price” and the multiplier, an interest in a pre-determinable possible outcome in the fixed time event.

2. The system of claim 1, wherein, if the user is an offering user, the option to exchange an interest in a pre-determinable possible outcome at the fixed option commitment is one or more of the group consisting of
a. an option to acquire the first pre-determinable outcome; and
b. an option to dispose of a second pre-determinable outcome different from the first pre-determinable possible outcome.

3. The system of claim 1, wherein, if the user is an acquiring user, the option to exchange an interest in a pre-determinable possible outcome at the fixed option commitment is one or more of the group consisting of
a. an option to dispose of the first pre-determinable outcome; and
b. an option to acquire a second pre-determinable outcome different from the first pre-determinable possible outcome.

4. The system of claim 1, wherein an operator of the networked system defines the strike price.

5. The system of claim 3, wherein the interest in the second predetermined possible outcome will yield a net result, being the strike price less the option commitment, if the second possible outcome is realized.

6. The system of claim 1, further configured to allow the respective user to dispose of the acquired interest in the second pre-determinable possible outcome before the end of the fixed time event.

7. The system of claim 4, wherein the fixed time event is a sporting event.

8. The system of claim 1, wherein the system is further configured to allow a user to confirm an interest with a single interaction on the input.

9. The system of claim 6, wherein the acquiring user's interest is factored up based on the multiplier if the pre-determinable outcome is realized.

10. The system of claim 4, wherein there are a plurality of offering and acquiring users and wherein the system is further configured to match multiple requests to acquire and offers of the first possible outcome, thereby defining commitments between multiple respective requesters and offerors.

11. The system of claim 5, wherein the second pre-determinable outcome is the opposite of the first pre-determinable outcome.

12. The system of claim 5, wherein the interest indicates a price per unit and a number of units.

13. The system of claim 5, wherein at least one of the plurality of remote devices is from the group consisting of a television receiver and a wireless device.

14. The system of claim 13, wherein the wireless device is one from the set consisting of a mobile telephone, a personal digital assistant and a personal computer.

15. The system of claim 5, wherein the display includes a real time data display of information relating to the fixed time event.

16. The system of claim 5, further including a mechanism to update information on the display at a user-defined interval.

17. A method for allowing users to register interests in at least one of a plurality of pre-determinable possible outcomes for a fixed-time event comprising:
a. linking a plurality of remote users;
b. displaying to at least one of the users, information about the fixed-time event;
c. allowing an offering user to offer an interest in a first pre-determinable possible outcome for the fixed time event at a given interest multiplier,
d. allowing an acquiring user to request an interest in the first pre-determinable possible outcome at the given multiplier,
e. matching at least a portion of the offer and the request to define a commitment by the acquiring user to acquire the requested interest at the given multiplier, and
f. giving users an option to exchange, at later time and at a fixed option commitment based on a pre-defined “strike price” and the multiplier, an interest in a pre-determinable possible outcome in the fixed time event.

18. The method of claim 17, wherein, if the user is an offering user, the option to exchange an interest in a pre-determinable possible outcome at the fixed option commitment is one or more of the group consisting of
a. an option to acquire the first pre-determinable outcome; and
b. an option to dispose of a second pre-determinable outcome different from the first pre-determinable possible outcome.

19. The method of claim 17, wherein, if the user is an acquiring user, the option to exchange an interest in a pre-determinable possible outcome at the fixed option commitment is one or more of the group consisting of
a. an option to dispose of the first pre-determinable outcome; and
b. an option to acquire a second pre-determinable outcome different from the first pre-determinable possible outcome.

20. The method of claim 17, further comprising defining the strike price.

21. The method of claim 19, wherein the interest in the second predetermined possible outcome will yield a net result, being the strike price less the option commitment, if the second possible outcome is realized.

22. The method of claim 17, wherein the respective user disposes of the acquired interest in the second pre-determinable possible outcome before the end of the fixed time event.

23. The method of claim 20, wherein the fixed time event is a sporting event.

24. The method of claim 17, wherein the a user confirms an interest with a single interaction on the input.

25. The method of claim 21, wherein the acquiring user's interest is factored up based on the multiplier if the pre-determinable outcome is realized.

26. The method of claim 20, wherein there are a plurality of offering and acquiring users and wherein match multiple requests to acquire are matched with multiple offers of the first possible outcome, thereby defining commitments between multiple respective requestors and offerors.

27. The method of claim 21, wherein the second pre-determinable outcome is the opposite of the first pre-determinable outcome.

28. The method of claim 21, wherein the interest indicates a price per unit and a number of units.

29. The method of claim 21, wherein the information is displayed to at least one user on a device from the group consisting of a television receiver and a wireless device.

30. The method of claim 29, wherein the wireless device is one from the set consisting of a mobile telephone, a personal digital assistant and a personal computer.

31. The method of claim 21, wherein the display includes a real time data display of information relating to the fixed time event.

32. The method of claim 21, wherein the information is updated on a display at a user-defined interval.
